(19) United States
(12) Patent Application Publication
(10) Pub. No.: US 2018/0043403 A1
(43) Pub. Date: Feb. 15, 2018

(54) METHOD FOR MACHINE-CLEANING WORKPIECES AND/OR MACHINE COMPONENTS, AND CLEANING SYSTEM

(71) Applicant: ZIPPEL GMBH, Neutraubling (DE)

(72) Inventors: Gunther ZIPPEL, Regensberg (DE); Jurgen HANNEMANN, Kemberg (DE)

(73) Assignee: ZIPPEL GMBH, Neutraubling (DE)

(21) Appl. No.: 15/546,950

(22) PCT Filed: Feb. 24, 2016
(86) PCT No.: PCT/EP2016/053873

§ 371 Date: Jul. 27, 2017

(30) Foreign Application Priority Data
Apr. 30, 2015 (DE) 10 2015 106 725.0

(51) Int. Cl. B08B 17/02; B08B 3/10; B25J 11/00; B08B 3/02

(52) U.S. Cl. CPC B08B 17/025; B08B 3/024; B08B 3/10; B25J 11/0085

(57) ABSTRACT

The invention relates to a method and a cleaning system for machine-cleaning workpieces and/or machine components received in at least one partly open cleaning chamber. A first aspect of the invention relates to a method for machine-cleaning workpieces or machine components received in at least one partly open cleaning chamber, wherein the workpieces or machine components to be cleaned are introduced into the cleaning chamber on a workpiece support and/or a rotary arrangement; at least one cleaning flow is generated by at least one lance device. The cleaning flow being supplied to at least some sections of the outer contour of the workpieces or machine components to be cleaned; and where the lance device can be moved along the outer contour of the workpiece or machine component to be cleaned in a controlled manner by a guiding and moving device dependent on a control routine which is executed in a control unit. Multiple cleaning sections are defined on the three-dimensional outer contour in an individual manner for the workpiece or machine component to be cleaned on the basis of test specifications for the residual dirt analysis of workpieces or machine components, and the control routine is generated based thereon. The lance device is guided at least to the ascertained cleaning sections in a controlled manner by means of the guiding and moving device, and each cleaning section is supplied with the cleaning flow in a controlled manner.

### BACKGROUND OF THE INVENTION

The invention relates to a method and a cleaning system for the machine cleaning of workpieces and/or machine components accommodated in at least one partly open cleaning chamber.

Methods and/or cleaning systems for cleaning workpieces, machine components and similar objects have been known for a long time.

Methods and/or cleaning systems of this type usually have a cleaning chamber enclosing a cleaning space. A workpiece carrier is arranged in the cleaning space, which is provided for accommodating cleaning workpieces, machine components and similar objects. For example, the workpiece carrier has three axes, each of which can be pivoted through 360° and which can be designed to be infinitely rotatable or pivotable and/or can be mounted on a corresponding rotary/pivoting arrangement.

Furthermore, a machine or industrial cleaning system comprises one or more lance devices, which can generate at least one cleaning flow for a wide range of cleaning purposes and can be arranged in a movable manner driven about three axes. Alternatively or additionally, a cleaning method of this type or a cleaning device of this type has various rinsing and/or filtering devices as well as supply and drainage lines for the cleaning and rinsing medium to be introduced into the cleaning space at least to some extent.

For cleaning the workpieces or machine components, the workpieces or machine components are introduced into the cleaning chamber and preferably accommodated by the workpiece carrier, i.e. fixed in a predetermined position for cleaning purposes. The cleaning or processing chamber can at least partially be filled or flooded with the cleaning and rinsing medium by means of the lance device and/or supply lines, specifically preferably in such a manner that a first rough cleaning of the workpieces or machine components takes place for rinsing away loose chips and chip debris in holes and/or on undercuts.

The requirements for the quality of the cleaning of such industrial cleaning machines are increasing considerably, however. For example, there is a requirement to free the workpieces or machine components or similar objects of dirt particles with a very small particle size, for example, a length of less than 200 μm and a width likewise of less than 200 μm, which are still adhering to the workpieces or machine components owing to machining production methods.

Furthermore, it is also often necessary and required in industrial manufacturing processes that the cleaned workpieces and/or machine components have a satisfactory technical cleanliness, which particularly satisfy the relevant standards, for example VDA 19 or ISO 16232. VDA 19 or ISO 16232 in this case describes the prescribed extraction method, analysis method and documentation of test results. Furthermore, owing to the constantly increasing cost pressure, the factor of cleaning time is of considerable importance. There is a constant effort in the field of industrial machine and component cleaning to keep the processing time of the individual workpieces or machine components as short as possible whilst achieving high cleaning quality.

### SUMMARY OF THE INVENTION

Based on this, it is an object of the invention to provide a method and a cleaning system for the machine cleaning of workpieces or machine components accommodated in at least one partially open cleaning chamber, which enable a more effective and more efficient cleaning of workpieces or machine components compared to the state of the art and particularly also satisfy the requirements for technical cleanliness according to VDA 19 or ISO 16232. To achieve this object, a method for the machine cleaning of workpieces or machine components accommodated in at least one partially open cleaning chamber is provided.

An important aspect of the method according to the invention for the machine cleaning of workpieces or machine components accommodated in at least one partially open cleaning chamber is to be seen in that the workpieces or machine components to be cleaned are introduced into the cleaning chamber on a workpiece carrier and/or a rotary arrangement. At least one cleaning flow is created by means of at least one lance device, the cleaning flow being impinged on the outer contour of the workpieces or machine components to be cleaned at least in certain sections. The lance device can advantageously be moved in a controlled manner along the outer contour of the workpiece or machine component to be cleaned by means of a guiding and moving device, specifically depending on a control routine executed in a control unit, wherein, depending on the testing requirements for the residual dirt analysis of workpieces or machine components for the workpiece or machine component to be cleaned in each case, a plurality of cleaning sections are defined individually on the three-dimensional outer contour and the control routine is created on the basis thereof. Subsequently, the lance device is guided in a controlled manner by means of the guiding and moving device at least onto the determined cleaning sections and the respective cleaning section is loaded with the cleaning flow in a targeted manner. As the method according to the invention suggests, inter alia, the cleaning of the workpiece or machine component depending on the testing requirements for the residual dirt analysis, that is to say whilst taking account of the guideline for technical cleanliness according to VDA 19 or ISO 16 232, to define a plurality of cleaning sections, individually in each case, on the three-dimensional outer contour for the workpiece or machine component and to create the control routine on the basis of that, the technical testing conditions predetermined by VDA 19 or ISO 16 232 are already specifically taken into account when the control routine is created, i.e. the component is subjected to cleaning in a targeted manner at the sections of the outer contour which are to be inspected. For this, the lance device is advantageously moved by means of the guiding and moving device in a manner controlled by means of the control routine, along the outer contour of the workpiece or machine component to be cleaned, specifically taking account of the testing parameters of VDA 19 or ISO 16 232. As a result, a considerably greater efficiency of the cleaning method is achieved compared to the state of the art. For example, the cleaning pressure of the cleaning flow and/or the volume of the cleaning flow required for cleaning and/or the cleaning duration can particularly advantageously be reduced effectively.

The workpieces or machine components to be cleaned are therefore loaded with the at least one cleaning flow in a targeted manner along the outer contour thereof and, by means of flow forces which are already reduced compared to the state of the art, a reliable and effective detachment, particularly of dirt particles or manufacturing debris, even of smaller particle size, adhered on and in the workpieces or machine components is achieved.

Furthermore advantageously, at least one cleaning section is assigned to at least one contour section and/or surface section of the three-dimensional outer contour of the workpiece or machine component.

The control routine is executed in at least one processor unit of the control unit, which is designed to determine the control data provided for controlling the guiding and moving device from design data, wherein the design data describe the three-dimensional outer contour of the workpiece or machine component, at least in certain sections. The control routine is therefore created in a completely automated or software-based manner, as the processor unit present in the control unit is designed to determine the control routine on the basis of available design data. Programming of the control routine by a user consequently is unnecessary. In particular, the control routine can therefore be created in an automated or software-based manner.

The contour sections and/or surface sections of the three-dimensional outer contour of the workpiece or machine component, which specify the cleaning sections can easily and quickly be converted into control data for controlling the guiding and moving device.

Also, in an advantageous design variant, control modules for the control routine can be stored in a memory unit interacting with the at least one processor unit, wherein predefined cleaning steps and/or cleaning flows are assigned by means of the control modules to the contour sections and/or surface sections or the assigned cleaning sections, which are loaded by means of the control routine and are executed in the processor unit. The loading of the control modules here takes place depending on the transmitted design data, which are created by a computer unit connected to the control unit and transmitted to the control unit. The computer unit is further connected to a display unit, which is at least designed for displaying three-dimensional graphical objects, specifically depending on the design data of the workpiece or machine component, which are stored in a design database stored in the computer unit. The three-dimensional graphical objects are preferably created as three-dimensional models of the workpiece or machine component with a resolution of at least 1200 dpi and stored in the design database.

In an advantageous embodiment, the lance device is supplied in a once or multiple times controlled manner at a plurality of cleaning sections in the same and/or different cleaning chambers. Also, before the supply to one or more cleaning sections, the lance device or cleaning elements accommodated by the same can be exchanged.

The cleaning quality is optically investigated by means of an inspection device, which can be arranged on the guiding and moving device, and subjected to another cleaning depending on the investigation.

For example, a continuous or pulsing or turbulent cleaning flow is created by means of the lance device. In particular, a suction jet flow or a sandblasting flow or a shot-peening flow or a water-jet-deburring flow can be created by the lance device.

In a preferred embodiment, an electric voltage, preferably a DC voltage of between 2 volts and 4 volts is applied between the workpiece or machine component and the cleaning chamber, wherein the workpiece or machine component preferably forms the anode and the cleaning chamber forms the cathode.

In the sense of the invention, expressions such as “essentially” or “approximately” mean deviations from respectively exact values by +/−10%, preferably by +/−5% and/or deviations in the form of changes that are of no importance for the function.

An associated cleaning system is also the subject of the invention. In addition, beneficial further developments, advantages and potential applications of the invention also result from the following description of exemplary embodiments and from the figures. All described and/or pictorially represented features are in principle the subject of the invention per se or in any desired combination, independently of their summarization in the claims or back reference thereof.

### BRIEF DESCRIPTION OF THE DRAWINGS

The invention is described in more detail in the following in connection with drawings on the basis of exemplary embodiments. In the figures:

FIG. 1 by way of example shows a schematic longitudinal section through a cleaning system, which is constructed for carrying out the method according to the invention;

FIG. 2 shows a very schematized top view onto a workpiece or machine component to be cleaned with a plurality of cleaning sections;

FIG. 3 shows a schematic block circuit diagram of a control unit for executing the control routine of the method according to the invention;

FIG. 4 by way of example shows a schematic top view of an embodiment of a cleaning system with three cleaning chambers, which are constructed for carrying out the method according to the invention; and

FIG. 5 by way of example shows a schematic top view of a further embodiment of a cleaning system with five cleaning chambers, which are constructed for carrying out the method according to the invention.

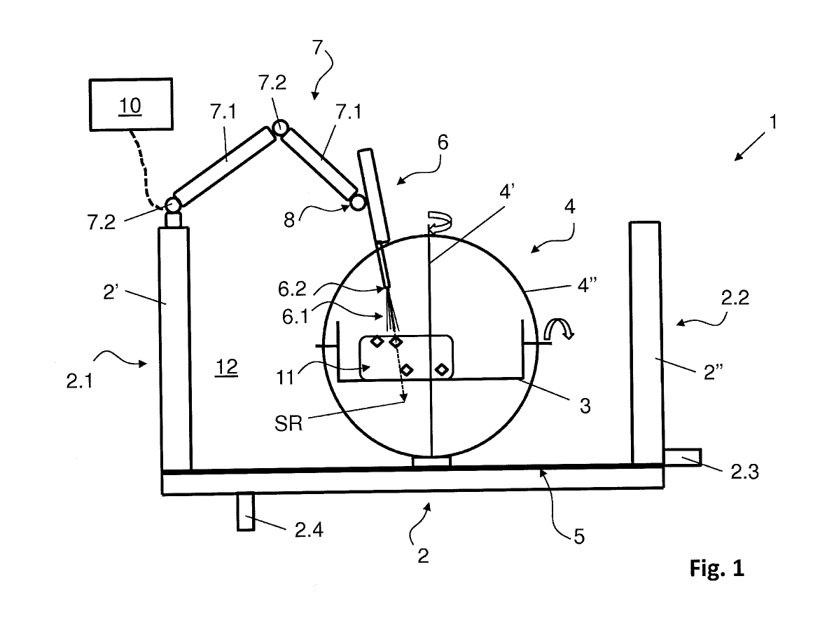

In FIG. 1, a cleaning system 1 is shown, the cleaning system for cleaning workpieces or machine components 11 is illustrated in a schematic longitudinal section and which the cleaning system is constructed for carrying out the method according to the invention. Furthermore, important aspects of the method, according to the invention, for the machine cleaning of workpieces or machine components 11, are explained in more detail using the example of this cleaning system 1.

The workpiece or machine component 11 to be cleaned, which is only illustrated schematically in FIG. 1, can in particular have a virtually arbitrary outer contour, which, for example, has a plurality of holes, undercuts, recesses and/or openings. Workpieces or machine components 11 of this type are preferably produced from metal by a machining production method.

Needless to say, additional components, such as cleaning, rinsing and/or filtering devices can be provided, which are not explicitly illustrated in the present FIGS. 1 to 5. For example, the filtration can be constructed as a 3-stage filtration in a filter housing with an enlarged usable filter surface compared to the past art.

The cleaning system 1 has at least one partially open cleaning chamber 2, which preferably forms, or at least partly encloses, a cleaning space 12, which is open at the top, and in which at least one workpiece carrier 3 can be arranged. Owing to the method according to the invention, compared to the known cleaning systems, the use of at least partially open cleaning chambers 2 is possible without problems.

For this, the cleaning chamber 2 can be constructed in a virtually rectangular manner in terms of the cross section thereof and in top view, so that a cuboidal overall geometry of the cleaning chamber 2 is set, wherein the cuboid does not have a closed upper side and thus is open at the top. Alternatively, the cleaning chamber 2 can have any desired cross-sectional shape, however, the cross section can be constructed to be virtually circular, oval, quadrilateral, trapezoidal or polygonal and in each case have an area sections which is open at the top.

Furthermore, the cleaning chamber 2 can have at least one opening 2.1, 2.2 on one of the two end faces 2′, 2″, which can be closed by a closure lid, which is provided on the respective end face 2′, 2″ and is not illustrated in any more detail, so that a basin-like cleaning chamber 2, which is open at the top, for accommodating a cleaning and/or rinsing medium is formed. Preferably, one opening 2.1, 2.2 can be provided in each case on each end face 2′, 2″ and the cleaning chamber 2 can be equipped on both sides with a closure lid which closes the respective opening 2.1, 2.2 in a sealed manner. The respective closure lid can be constructed such that it can be hinged against the corresponding opening 2.1, 2.2 in a sealing manner, particularly in a liquid-tight manner, by a pneumatic device.

Furthermore, for supplying and draining the cleaning and/or rinsing medium into the cleaning chamber 2, at least one supply opening 2.3 and/or a drainage opening 2.4 can be provided. In the present exemplary embodiment, a supply opening 2.3 is provided in the region of the end face 2″ and a drainage opening 2.4 is provided in the base region of the cleaning chamber 2.

The holding volume of the cleaning chamber 2 is adapted to the cleaning task, i.e. to the dimensioning and/or number of workpieces and/or machine components 11 to be cleaned and may therefore vary. The wall thickness of the cleaning chamber 2 can consequently be based on the total weight of the workpieces or machine components 11 and the holding volume thereof.

The workpiece carrier 3, provided in the cleaning chamber 2, is constructed for accommodating at least one workpiece or machine component 11 or similar objects to be cleaned. This workpiece carrier can be formed by an arrangement of a plurality of carrier elements/mounts or an accommodating basket and/or accommodating container, preferably a skeleton container, wherein the accommodating basket and/or the accommodating container is provided for accommodating workpieces or machine parts present in the form of bulk material.

The workpiece carrier 3 can be provided preferably rotatably and/or pivotably in the cleaning chamber 2, by a rotary arrangement 4. The rotary arrangement 4 can be formed by two arcuate guide elements 4′, 4″, which are in each case fastened to one another such that they can move preferably through 360° and thus allow a three-dimensional rotation/pivoting of the accommodated workpiece carrier 3. The rotational movability of the guide elements 4′, 4″ is indicated in FIG. 1 with corresponding arrows. For example, the guide elements 4′, 4″ of the rotary arrangement 4 can be controlled, for the respective rotational movability thereof, independently of one another by infinitely variably pulse-controlled servo valves. In particular, the rotary arrangement 4 is operated with four revolutions per minute.

Furthermore, the workpieces or machine components 11 to be cleaned can be introduced into the cleaning chamber 2 by the end-face opening 2.1. For this purpose, the workpiece carrier 3 can preferably be loaded with the workpieces or machine components 11 or similar objects manually or automatically. The workpieces or machine components 11 are preferably fixed on the workpiece carrier 3 by corresponding holders, which are not illustrated further. Handling units, linear slide units or robot units can be provided for automatic loading.

Alternatively, it is also possible to introduce the workpieces or machine components 11 to be cleaned into the cleaning chamber 2 not being arranged on the workpiece carrier 3, but rather to fasten the same directly on the rotary arrangement 4 by corresponding holders or locating pins and to introduce the same into the cleaning chamber 2 using the rotary arrangement 4.

A cleaning-system conveyor 5 can be provided for introducing the workpieces or machine components 11 to be cleaned into the cleaning chamber 2, which can be a belt and/or chain conveyor and which is set up to convey or to move the workpiece carrier 3 at least in the at least one cleaning chamber 2 in and/or counter to a transport direction A at a transport speed which is clocked and/or constant in a defined manner.

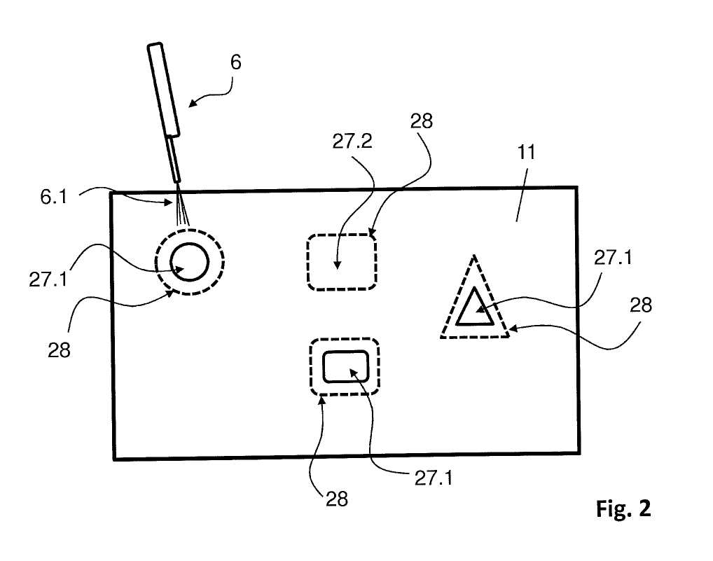

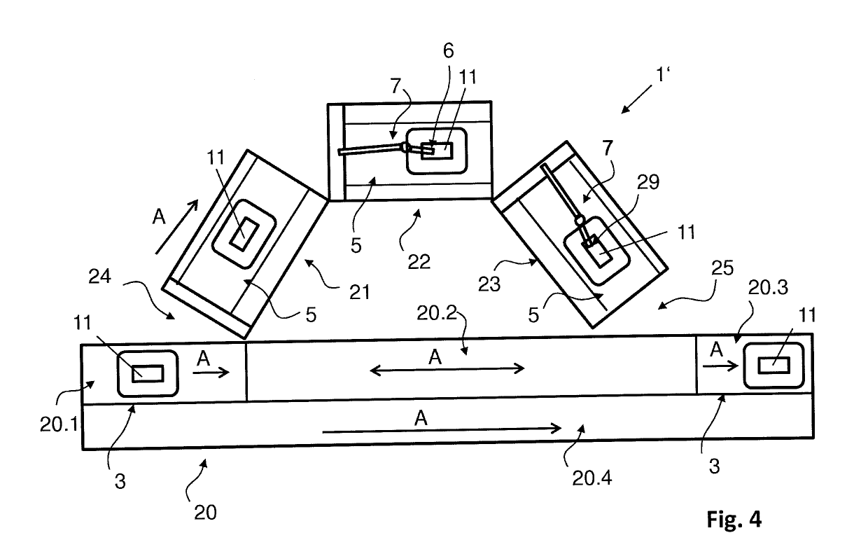

As shown by way of example in FIG. 4, an adjacent conveying system or an adjacent conveyor 20 can be provided, on which the contaminated workpieces or machine components 11 are conveyed in an automated clocked manner and/or at a transport speed which is constant in a defined manner, in particular to an intake 24 of the cleaning system 1, which has three cleaning chambers 2.1, 2.2, 2.3 in the embodiment shown in FIG. 2, and accepted again coming from an outflow 24 of the cleaning system 1. Furthermore, the adjacent conveyor 20 can have a plurality of conveying sections, a first to a fourth conveying section 20.1 . . . 20.4 in the embodiment shown in FIG. 2. In this case, the first conveying section 20.1 can be set up to convey the workpieces or machine components 11 in the transport direction A to the inflow 24 of the cleaning system 1, whereas the third conveying section 20.3 is set up to accept the workpieces or machine components 11 from the outflow 25 and convey the same further in transport direction A. A second conveying section 20.2 can be provided between the first and third conveying sections 20.1, 20.3, which is designed to convey the workpieces or machine components 11 between the first and third conveying sections 20.1, 20.3 or to hand over to the first and/or third conveying section 20.1, 20.3. For this purpose, the second conveying section 20.2 is in particular designed to convey the workpieces or machine components 11 in and/or counter to the transport direction A. In addition, a fourth conveying section 20.4 can be provided, which conveys the workpieces or machine components 11 past the cleaning system 1, in transport direction A. To hand over or transfer workpieces or machine components 11, points-like branches can be provided between the individual conveying sections 20.1 . . . 20.4. The first to fourth conveying sections 20.1 . . . 20.4 can be formed as a belt or chain conveyor or optionally a combination of both types of conveyor.

The workpiece carriers 3, which are indicated—that is to say have an index, are in this case assigned to the adjacent conveyors 20 in particular, which workpiece carriers are handed over in particular via the first conveying section 20.1 to the inflow 24 of the cleaning system 1 and therefore to the cleaning-system conveyor 5 assigned to the cleaning system 1. For example, points-like branches can be provided for the indicated workpiece carriers 3 for transferring or handing over the indicated workpiece carriers 3 from the adjacent conveyor 20 to the cleaning-system conveyor 5. Loading the rotary arrangements 4 assigned at least to the cleaning-system conveyor 5 with the indicated workpiece carriers 3 of the adjacent conveyor 20 can in particular take place in an automated manner, by means of handling units or robot units.

Alternatively, dedicated indicated workpiece carriers 3 can be assigned to the cleaning-system conveyor 5, so that in this case no points-like branches have to be provided between the two conveyors, that is to say the adjacent conveyor 20 and the cleaning-system conveyor 5, but rather, a preferably automated loading or repacking of the contaminated workpieces or machine components 11 from the workpiece carriers 3 of the adjacent conveyor 20 onto the workpiece carriers 3 and/or rotary arrangement 4 of the cleaning-system conveyor 5 can take place. In this case, dedicated workpiece carriers 3 are assigned to each of the conveyors 5 or 20, which workpiece carriers are only used on the corresponding conveyor 5 or 20.

Alternatively, it is also possible to introduce the contaminated workpieces or machine components 11 into the cleaning chamber 2 by a guiding and moving device, which is not illustrated in any more detail and may be constructed as a robot arm. For this, the indicated workpiece carriers 3 of the adjacent conveyor 20 can be accommodated or accepted and introduced into the cleaning chamber 2 by the guiding and moving device.

Furthermore, the cleaning system 1 has at least one lance device 6, by which at least one cleaning flow 6.1 can be created, using which the outer contour of the workpieces or machine components 11 to be cleaned can be loaded at least in certain sections. The at least one cleaning flow 6.1 can in this case be formed as a rinsing flow having an aqueous alkaline cleaning or rinsing medium, which preferably has a rinsing temperature of between 50° C. and 55° C. A cleaning flow 6.1 with a flow pressure of between 2 and 4 bar at a flow volume of 0.5 to 1.0 litre per minute can be created for that purpose by the at least one lance device 6.

Furthermore, the lance device 6 can be designed to create a pulsing cleaning flow 6.1, that is to say a cleaning flow with a varying flow pressure. The at least one lance device 6 can in this case have, in the region of the opening orifice 6.2 thereof, both a conical annular nozzle with a spray cone, which rotates in a controllable manner, for creating a turbulent cleaning flow 6.1 and also additionally a central full jet nozzle for creating a full-jet cleaning flow 6.1, wherein the full-jet nozzle and the conical annular nozzle of the lance device 6 can be operated separately and/or simultaneously.

Alternatively or cumulatively, the lance device 6 can also be designed to create at least one cleaning flow 6.1, which is formed as a high-pressure dry-steam flow and provides a steam temperature of between 300° C. and 400° C., preferably 350° C. and a steam pressure of between 6 bar and 10 bar, preferably 8 bar. Here, in the context of the present invention, dry steam, also termed hot steam or superheated steam, is understood to mean a steam with a temperature above the boiling temperature. The steam is therefore “dry” and in particular no longer contains water droplets, so that this steam corresponds to a gas in terms of the physical behaviour thereof. Dry steam is created when the temperature and the pressure of a liquid in a dry steam generator specially constructed for that, is increased to such an extent that what is known as the critical point is exceeded and a “super-critical” state is reached. Lance devices 6 of this type for creating a dry steam flow are known to the person skilled in the art.

In turn, alternatively or cumulatively, the lance device 6 can be designed to create at least one cleaning flow 6.1, which is constructed as a particle flow for spraying the outer contour of the workpieces or machine components 11. For this purpose, the lance device 6 can in particular create a cleaning flow 6.1, which can be constructed as a suction jet flow and/or a sandblasting flow and/or a shot-peening flow and/or a water-jet-deburring flow.

Advantageously, the respective one cleaning flow 6.1 has at least one flow direction SR, which can be orientated in a controlled manner onto the outer contour of the workpiece or machine component 11 to be cleaned.

According to the invention, the at least one lance device 6 is arranged on a guiding and moving device 7 and interacts with the same, wherein the lance device 6 can be moved in a controlled manner along the outer contour of the workpiece or machine component 11 to be cleaned by the guiding and moving device 7, specifically depending on a control routine STR executed in a control unit 10. By the targeted controlled guidance of the at least one lance device 6 depending on the control routine STR executed in the control unit 10, the at least one cleaning flow 6.1 created by the lance device 6, with its flow direction SR can be directed in a targeted manner onto the outer surface of the contaminated workpieces and machine components 11 and adhering dirt particles or emulsions, such as for example oils, greases, drawing greases, chips, threads, agglomerates, dust particles, plastic particles and/or other particles, are removed effectively.

In particular, the lance device 6 is guided or tracked along the outer contour of the workpieces or machine components 11 in such a controlled manner that the distance of the opening orifice 6.2 of the lance device 6 from the outer contour of the workpieces or machine components 11 to be cleaned is between 1 mm and 50 mm, preferably 5 mm to 30 mm. Thus, the cleaning flow 6.1 created by the lance device 6 and emerging from the opening orifice 6.2 thereof in the flow direction SR for example has a free jet length of between 1 mm and 50 mm, particularly preferably between 5 mm and 30 mm.

For example, the guiding and moving device 7 can be constructed as a robot kinematics having a plurality of rotational and/or movement axes, which robot kinematics has a plurality of robot arms 7.1, which are connected to one another in a rotatable or pivotable manner about a rotational axis 7.2. The guiding and moving device 7 can in this case be arranged in the region of one of the end faces 2′, 2″, particularly at the free upper edges thereof, and engage from above in a controlled manner into the cleaning chamber 2, which is open at the top.

Alternatively, a guiding and moving device 7 for a plurality of cleaning chambers, the cleaning chambers 22, 23 shown in FIG. 4, can also be provided, in that the guiding and moving device 7 is arranged next to the respective cleaning chambers 22, 23, with which it interacts. Here also, the arrangement is realized in such a manner that the guiding and moving device 7 engages from above into the respective cleaning space 12, i.e. via the respective opening of the cleaning chamber 22, 23. In particular, the guiding and moving device 7 can be guided in a controlled manner with a feed rate of 0.8 to 1.2 m per second, preferably with a feed rate of 1.0 m per second. To this end, the guiding and moving device 7 has one or more motor units, which are not illustrated in any more detail in the figures, but can be controlled by the control unit 10.

Furthermore, the guiding and moving device 7 can comprise an exchange device 8, which is only schematically indicated and which can be constructed as a quick coupling, by which a separable mechanical connection, i.e. detachable fastening, between the guiding and moving device 7 and the respective lance device 6 can be produced, and which allows a quick and uncomplicated exchange or change between different lance devices 6. The exchange device 8 can also be actuated in a controlled manner by the control unit 10.

Furthermore, it is also possible to provide a lance carrier element, which is not illustrated in any more detail, on the guiding and moving device 7, particularly in a detachable manner, on the exchange device 8, on which a plurality of lance devices 6 can then be arranged in turn, specifically in such a manner that the plurality of lance devices 6 mutually form substantially parallel running flow directions SR of the respective cleaning flows 6.1. Advantageously, a plurality of workpieces or machine components 11 can therefore be cleaned simultaneously in parallel inside a single cleaning chamber, for example the cleaning chamber 2. Here, a lance device 6 is assigned to one workpiece or component in each case.

Advantageously, the workpiece or machine component 11 to be cleaned can be positively charged with a direct current of 2 to 3 volts during the entire cleaning method, that is to say be connected as an anode, and the minus pole, that is to say the cathode, can be applied at the earthed cleaning chamber 2. Preferably, the current intensity in this case is set to less than 0.1 amps and salt ions are added to the cleaning and rinsing medium, which is accommodated in the cleaning chamber 2, so that a supporting electro-galvanic cleaning takes place at the workpiece or machine component 11 to be cleaned. For this, the workpiece or machine component 11 to be cleaned is at least partially immersed into the cleaning and rinsing medium.

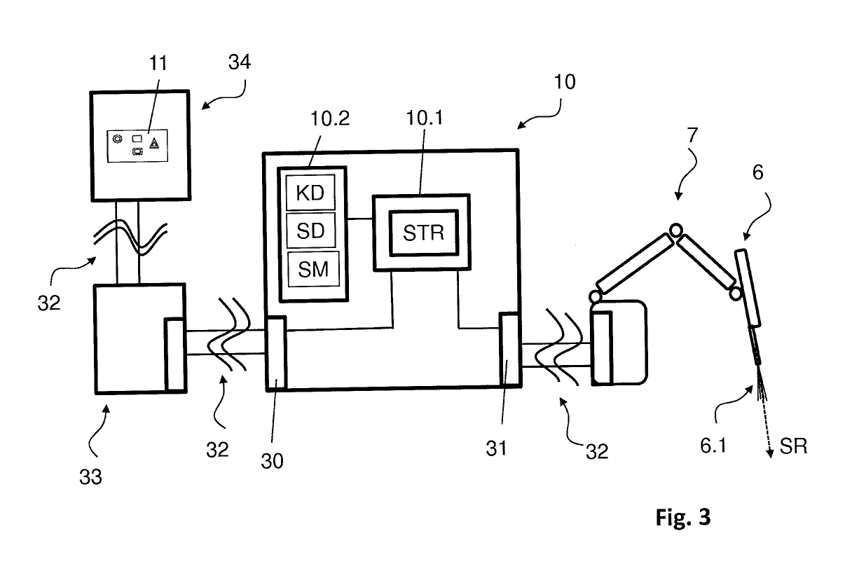

As illustrated in more detail in FIGS. 2 and 3, according to the invention, a plurality of cleaning sections 28 are defined for the workpiece or machine component 11 to be cleaned individually on the three-dimensional outer contour, depending on the testing requirements for the residual dirt analysis of workpieces or machine components, that is to say depending on VDA 19 or ISO 16232, and based on that the control routine is created, wherein subsequently the lance device 6 is guided in a controlled manner at least to the determined cleaning sections 28 by the guiding and moving device 7, and the respective cleaning section 28 is loaded in a targeted manner with the cleaning flow 6.1.

In particular, FIG. 2 shows a view of a side face of a workpiece or machine component 11 and therefore a portion of the outer contour thereof in a very schematized illustration. Furthermore, the lance device 6 is indicated, by which the outer contour of the workpiece or machine component 11 is loaded with the created cleaning flow 6.1 at least in certain sections. The outer contour of the workpiece or machine component 11 can have one or more geometric contour sections 27.1, which deviate from a planarly formed component surface in particular, holes and/or undercuts and/or recesses and/or openings, etc. with different diameters and/or depths and/or threads, which, for ensuring technical cleanliness according to the standards VDA 19 or ISO 16 232, must be subjected to cleaning with a satisfactory cleaning quality. Knowing the cleaning quality of the testing requirements, that is to say depending on the testing parameters of the testing requirements for the residual dirt analysis, a cleaning section 28 is assigned to these contour sections 27.1 in each case, which surrounds the respective contour section 27.1 to be cleaned on the outer contour of the workpiece or machine component 11.

The cleaning sections 28 can be planarly constructed surface sections 27.2 of the three-dimensional outer contour of the workpiece or machine component 11, which must have a predetermined cleaning quality which is determined by the testing parameters of the testing requirements for the residual dirt analysis of workpieces or machine components 11.

According to the invention, knowing the cleaning quality for certain contour sections 27.1 or surface sections 27.2 required by VDA 19 or ISO 16 232, one or more cleaning sections 28 are defined accordingly and the lance device 6 is guided in a controlled manner by the guiding and moving device 7 at least to the determined cleaning sections 28 and the respective cleaning section 28 is loaded in a targeted manner with the at least one cleaning flow 6.1.

Depending on the surface quality or structure, a plurality of cleaning sections 28 on the three-dimensional outer contour are therefore defined individually for the component or workpiece, specifically depending on the testing requirements for the residual dirt analysis, and based on that the control routine STR for guiding the lance device 6 by the guiding and moving device 7 is created, which guides the lance device 6 at least to the determined cleaning sections 28 and subsequently loads the respective cleaning section 28 with a or a specially selected cleaning flow 6.1 in a targeted manner.

FIG. 3 shows a schematic block circuit diagram of a control unit 10, in which the control routine STR according to the invention is carried out. For this, the control unit 10 has at least one processor unit 10.1 for executing the control routine STR, a memory unit 10.2 interacting with the processor unit 10.1 for the at least temporary storage of process parameters and/or control data, and a first and second interface 30, 31. The processor unit 10.1 is in particular designed to convert design data KD received at the first interface 30 of the control unit 10 into control data SD by the control routine STR, which control data can be transmitted to the guiding and moving device 7 via the second interface 31, in order to move the guiding and moving device in a controlled manner, depending on the control data SD or control commands created by the control routine STR. In other words, the control unit 10 is therefore designed for the automated or software-based creation of the control routine STR, in that the processor unit 10.1 of the control unit 10 creates the control data SD for the control routine STR in a software-based manner on the basis of design data SD or converts the same into control data SD.

Already predetermined control modules SM for the control routine STR can also be stored in the memory unit 10.2. Already predefined cleaning steps and/or cleaning flows 6.1 can be assigned to the predetermined contour sections 27.1 and/or surface sections 27.2 of the three-dimensional outer contour of workpieces or machine components 11, which can then be loaded by the control routine STR and executed in the processor unit 10.1. Also, in addition to the dimensioning of the cleaning section 28, the type and quality of the cleaning flow 6.1 and/or the angle of incidence and/or the distance of the cleaning nozzle from the cleaning section 28 can also be predetermined on the basis of such control modules for the different contour sections 27.1 and/or surface sections 27.2. The cleaning process to be carried out at a cleaning section 28 can therefore be determined individually by the respective control module SM.

In this case, a wireless or wired data transmission path 32 can be provided for transmitting the control data SD or control commands between the second interface 31 and the guiding and moving device 7. The first interface 30 is in this case connected via a data transmission path 32 for transmitting the design data KD to a computer unit 33, which can be realized as a personal computer, laptop or tablet. The computer unit 33 is here designed for creating design data KD and has the program routines required for this.

Furthermore, the computer unit 33 is connected to a display unit 34, specifically the display unit can be connected to the computer unit 33 or integrated in the same. The display unit 34 is constructed for displaying three-dimensional graphical objects, particularly the three-dimensional outer contour of the workpieces or machine components 11. For example, the geometric design data KD of the workpiece or machine component 11 describing the three-dimensional outer contour can be stored in a design database stored in the computer unit 33 and the design data KD are created on the basis of the graphical objects illustrated by the display unit 34 or the three-dimensional outer contour thereof. For this, the cleaning sections 28 predetermined by the testing requirements for the residual dirt analysis of workpieces or machine components 11 are selected on the three-dimensional outer contour of the workpiece or machine component 11 illustrated on the display unit 34, either manually or in a software-based manner, and subsequently the design data KD reproducing these cleaning sections 28 are transmitted to the control unit 10.

In particular, the design data KD can be created in such a manner by the computer unit 33 that cleaning sections 28 already predefined in a software-based manner are assigned to certain graphical contour sections 27.1 and/or graphical surface sections 27.2 of workpieces or machine components 11, which cleaning sections are stored in the design database. In this case, the graphical objects can be stored in the design database, in particular as three-dimensional models of the workpiece or machine component 11 with a resolution of at least 1200 dpi, and displayed by the display unit 34. Alternatively, the three-dimensional graphical objects can also already be stored in the computer unit 33 as preferably stp files and/or scanned in with a resolution of at least 1200 dpi in each case.

Consequently, the workpieces or machine components 11 with their contour sections 27.1 and/or surface sections 27.2 can be displayed using the display unit 34 and a plurality of cleaning sections 28 can be defined for the workpiece or machine component 11 to be cleaned individually on the three-dimensional outer contour, depending on the testing requirements for the residual dirt analysis or workpieces or machine components 11, and the design data KD are created from that by the computer unit 33.

By way of example, FIG. 4 shows a cleaning system 1′ with a first to third cleaning chamber 21, 22, 23, which are in principle constructed identically to the cleaning chamber 2 of FIG. 1. In this case, the workpiece carriers 3, to which the workpieces or machine component 11 to be cleaned are assigned, are handed over from the adjacent conveyor 20 to the cleaning-system conveyor 5 assigned to the cleaning system 1′ and guiding the workpiece carrier 3 through at least the first to third cleaning chambers 21, 22, 23 in the manner described in more detail above.

In the illustrated embodiment of FIG. 4, the workpiece carriers 3 of the adjacent conveyor 20 are repacked onto the rotary arrangements 4 assigned to the cleaning system 1′ and introduced or conveyed into the first cleaning chamber 21 by the cleaning-system conveyor 5. Preferably, the workpiece or machine component 11 to be cleaned can be immersed in such a manner by the rotary arrangement 4 into a water bath provided in the first cleaning chamber 21 and at least containing salt ions, that the workpiece or machine component 11 assigned to the respective rotary arrangement 4 is preferably pivoted or immersed into the water bath preferably up to a third of the component height thereof, at least three times for each component side. The cleaning chamber 21 can for this purpose also at least partially be filled or flooded with a cleaning and rinsing medium, specifically preferably in such a manner that a first rough cleaning of the workpieces or machine components takes place for rinsing away loose chips and chip debris in holes and/or on undercuts.

Advantageously, the workpiece or machine component 11 to be cleaned can be positively charged with a direct current of 2 to 3 volts at least during the pivoting process, that is to say be connected as an anode, and the minus pole, that is to say the cathode, can be applied at the earthed cleaning chamber 2. Preferably, the current intensity in this case is set to less than 0.1 amps.

The second or third cleaning chambers 22, 23 in this case respectively comprise the guiding and moving device 7 described in more detail in with respect to FIG. 1, including the control unit 10 interacting therewith. In particular, a lance device 6 can in this case be assigned to the second cleaning chamber 22 during the first-time travelling of the plurality of cleaning sections 28, that is to say a first cleaning step, which lance device is designed to create at least one cleaning flow 6.1, which is formed as an aqueous alkaline rinsing flow. Furthermore, between the first-time and the subsequent travelling of the plurality of cleaning sections 28, that is to say a second cleaning step, a preferably automated exchange of the lance device 6 can be carried out and the lance device 6 can be designed during the second run through of the plurality of cleaning sections 28 to create at least one cleaning flow 6.1 which is formed as a high-pressure dry-steam flow. It is therefore possible to provide that in one and the same cleaning chamber, here the cleaning chamber 22, various cleaning steps or processes can be executed—in this case rinsing by the alkaline rinsing flow—in a first cleaning step and drying by high-pressure dry-steam flow in a second cleaning step. Alternatively however, it would also be possible to provide the various cleaning steps or processes in separate, that is to say different cleaning chambers.

Particularly advantageously, the plurality of cleaning sections 28 can be travelled multiple times controlled in an identical manner, and, between the multiple controlled travel of all cleaning sections 28, an exchange of the respective lance device 6 can be provided at the guiding and moving device 7, so that during the first run through of the plurality of cleaning sections 28, that is to say a chronological run through in turn of all successive cleaning sections 28, a targeted cleaning and, during the second run through, that is to say another chronological run through in turn of all cleaning sections 28, a likewise targeted drying of the previously cleaned sections of the outer contour of the workpieces or machine components 11 to be cleaned takes place, in that one and the same cleaning sections 28 are travelled completely multiple times in the cleaning chamber 22 and subjected to a plurality of cleaning steps.

Alternatively, it is also possible, between the individual cleaning sections 28 of a complete run through of all cleaning sections 28, to carry out one or more changes of the lance device 6 on the guiding and moving device 7, in order to, for example, first clean and subsequently dry one and the same cleaning section 28 of a workpiece, or machine component 11, in a targeted manner, to be cleaned whilst running through all cleaning sections 28, before the remaining cleaning sections 28 are travelled in a controlled manner.

Finally, subsequently, using available inspection systems, an optical inspection of the cleaning quality of the previously cleaned workpieces or machine components 11 can take place at the plurality of cleaning sections 28.

If in this case, one or more residual dirt particles are optically detected by the inspection device 29 in one or more cleaning sections 28, which does not fulfil the technical parameters in VDA 19 or ISO 16 232, then the workpiece or machine component 11 can be handed over via the outflow 25 to the second conveying section 20.2 and supplied anew by the same, counter to the transport direction A, to the cleaning system 1′, via the inflow 24.

Subsequently, a targeted recleaning of this cleaning section 28 furnished with one or more residual dirt particles can take place in the cleaning system 1′, in the second cleaning chamber 22, in that the lance device 6 is moved into this cleaning section 28 by means of the guiding and moving device 7 in a controlled manner, specifically depending on the control routine executed in the control unit 10. Subsequently, at least one cleaning flow 6.1 can be created by means of the lance device 6, which cleaning flow can be formed as an aqueous alkaline rinsing flow, in order to thus remove the one or more residual dirt particles in this cleaning section 28 in a targeted manner. If the residual dirt particles are present in a plurality of cleaning sections 28, then the plurality of cleaning sections 28 furnished with a residual dirt particle can successively be travelled to and cleaned.

One or more cleaning chambers 21, 22, 23, not illustrated in FIG. 4, could also be present in a redundant manner in the cleaning system 1′, in order then to connect this cleaning chamber 21, 22, 23, kept in a redundant manner as a “standby” cleaning chamber, in the event of a failure of one of the cleaning chambers 21, 22, 23.

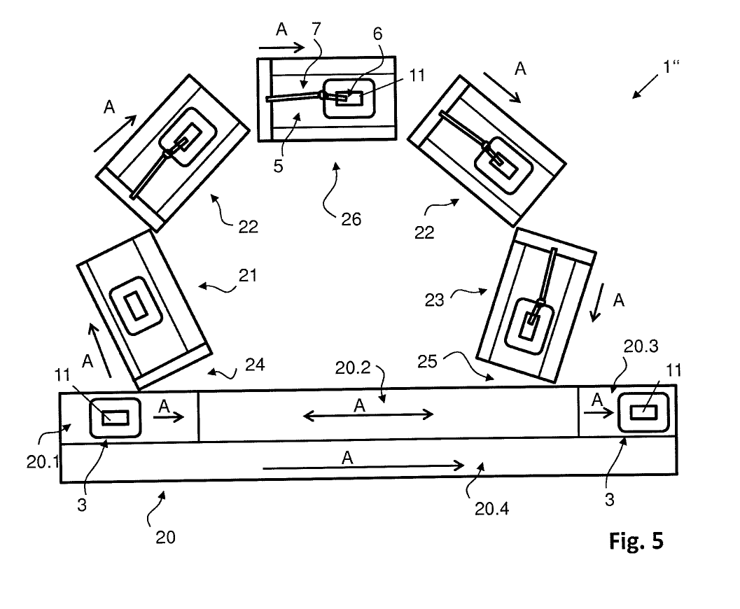

FIG. 5 shows a further design variant of a cleaning system 1″ with five cleaning chambers 21, 22, 23 and 26, wherein the cleaning chamber 22 is present in a redundant manner. The cleaning chamber 21, 22, 23 of the cleaning system 1″ of FIG. 5 are in this case realized identically to the cleaning chambers 21, 22, 23 of the cleaning system 1′ of FIG. 4, specifically with regards to the lance device 6 used thereby and the cleaning flow 6.1 generated therewith. Furthermore, in a deviation from the cleaning system 1′ of FIG. 4, the cleaning system 1″ of FIG. 5 provides the further cleaning chamber 26, to which a lance device 6 can be assigned when travelling the plurality of cleaning sections 28, which lance device is designed to create at least one cleaning flow 6.1, which is formed as a particle flow for spraying the outer contour of the workpieces or machine components 11. For this purpose, the lance device 6 can form a cleaning flow 6.1, which can be constructed as a suction jet flow and/or a sandblasting flow and/or a shot-peening flow and/or a water-jet-deburring flow. It can therefore be provided that in one and the same or a different cleaning chamber, at least one cleaning flow 6.1 is subsequently created by the lance device 6, which cleaning flow can be formed as an aqueous alkaline rinsing flow, in order to thus remove the one or more residual dirt particles in this cleaning section 28 in a targeted manner. Furthermore, a subsequent drying can take place.

The invention was previously described on the basis of an exemplary embodiment. It is understood that numerous changes and modifications to the subject of the invention are possible without departing from the inventive idea as a result.

### REFERENCE LIST

1, 1′, 1″ Cleaning system
2 Cleaning chamber
2′, 2″ End faces
2.1, 2.2 Opening
2.3 Supply opening
2.4 Drainage opening
3 Workpiece carrier
4 Rotary arrangement
4′, 4″ Guide elements
5 Cleaning-system conveyor
6 Lance device
6.1 Cleaning flow
6.2 Opening orifice
7 Guiding and moving device
7.1 Robot arm
7.2 Rotary spindle
8 Exchange device
10 Control unit
10.1 Processor unit
10.2 Memory unit
11 Workpiece or machine component
12 Cleaning space
20 Conveyor
20.1 . . . 20.4 First to fourth conveying section
21 First cleaning chamber
22 Second cleaning chamber
23 Third cleaning chamber
24 Inflow
25 Outflow
26 Fourth cleaning chamber
27.1 Contour sections
27.2 Surface sections
28 Cleaning section
29 Inspection device
30 First interface
31 Second interface
32 Data transmission path
33 Computer unit
34 Display unit
A Transport direction
KD Design data
SD Control data
SM Control module
SR Flow direction
STR Control routine

1. A method for the machine cleaning of workpieces or machine components accommodated in at least one partially open cleaning chamber, comprising the steps of:
introducing the workpieces or the machine components to be cleaned into the at least one partially open cleaning chamber on a workpiece carrier or a rotary arrangement, in which at least one cleaning flow is created by of at least one lance device, an outer contour of the workpieces or the machine components to be cleaned are loaded at least in certain sections,
moving the lance device in a controlled manner along the outer contour of the workpiece or the machine component to be cleaned by of a guiding and moving device, depending on a control routine executed in a control unit, in which, depending on testing requirements for a residual dirt analysis of workpieces or machine components for the workpiece or machine component to be cleaned, a plurality of cleaning sections are defined individually on a three-dimensional outer contour and a control routine (STR) is created on the basis thereof, and
guiding the lance device in a controlled manner by the guiding and moving device at least onto the plurality of cleaning sections and the plurality of cleaning sections is loaded with at least one cleaning flow in a targeted manner.

2. The method according to claim 1, wherein the plurality of cleaning sections is assigned to at least one contour section or surface section of the three-dimensional outer contour of the workpiece or machine component.

3. The method according to claim 1, wherein the control routine (STR) is executed in at least one processor unit of the control unit, the control unit determines the control data (SD) provided for controlling the guiding and moving device from design data (KD), wherein the design data (KD) describes the three-dimensional outer contour of the workpiece or machine component at least in certain sections.

4. The method according to claim 1, wherein control modules (SM) for the control routine (STR) are stored in a memory unit interacting with at least one processor unit.

5. The method according to claim 4, wherein predefined cleaning steps or cleaning flows are assigned by the control modules (SM) to the contour sections or the surface sections or the assigned cleaning sections which are loaded by the control routine (STR) and are executed in the at least one processor unit.

6. The method according to claim 3, wherein the design data (KD) are created by a computer unit connected to the control unit and transmitted to the control unit.

7. The method according to claim 6, wherein the computer unit is further connected to a display unit, which is displays three-dimensional graphical objects.

8. The method according to claim 6, wherein the design data (KD) of the workpiece or machine component are memorized in a design database stored in the computer unit.

9. The method according to claim 8, wherein the three-dimensional graphical objects are created as three-dimensional models of the workpiece or machine component with a resolution of at least 1200 dpi and stored in the design database.

10. The method according to claim 1, wherein the lance device is guided in a controlled manner at least one time at a plurality of cleaning sections in the same or different cleaning chambers.

11. The method according to claim 1, wherein the lance device or cleaning elements accommodated by the lance device are exchanged between the cleaning of one or more cleaning sections.

12. The method according to claim 1, wherein an optical inspection of the cleaning quality is carried out by an inspection device arranged on the guiding and moving device.

13. The method according to claim 1, wherein at least one continuous, pulsing or turbulent cleaning flow is created by the lance device.

14. The method according to claim 1, wherein a suction jet flow, a sandblasting flow, a shot-peening flow or a water-jet-deburring flow is created by the lance device.

15. The method according to claim 1, wherein an electric voltage of between 2 volts and 4 volts is applied between the workpiece or machine component and the cleaning chamber, wherein the workpiece or machine component forms an anode and the cleaning chamber forms a cathode.

16. A cleaning system for machine cleaning of workpieces or machine components accommodated in at least one partially open cleaning chamber, the system comprises:
arranging the workpieces or machine components to be cleaned in the at least one partially open cleaning chamber on a workpiece carrier or a rotary arrangement,
providing at least one lance device for creating at least one cleaning flow using the at least one lance device to clean an outer contour of the workpieces or machine components that have been loaded at least in certain sections,
moving the lance device in a controlled manner along the outer contour of the workpieces or machine components to be cleaned by a guiding and moving device, specifically depending on a control routine (STR) executed in a control unit, wherein, depending on testing requirements for a residual dirt analysis of workpieces or machine components for the workpieces or machine components to be cleaned, a plurality of cleaning sections are defined individually on a three-dimensional outer contour and the control routine (STR) is created on the basis thereof,
and the control routine is for guiding the lance device by the guiding and moving device at least to the determined cleaning sections and for targeted loading of the respective determined cleaning sections using the at least one cleaning flow.
